(19) United States
(12) Patent Application Publication
(10) Pub. No.: US 2005/0190280 A1
(43) Pub. Date: Sep. 1, 2005

(54) Method and apparatus for a digital camera scrolling slideshow

(76) Inventors: William Robert Haas, Fort Collins, CO (US); Kirk Steven Tecu, Greeley, CO (US); Jim Voss, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/788,762

(22) Filed: Feb. 27, 2004

(51) Int. Cl. H04N 5/222; G09G 5/00

(52) U.S. Cl. 348/333.05; 715/730; 715/784

(57) ABSTRACT

A digital camera and related methods enable a scrolling slideshow of captured images across a display screen. The display screen can be the digital camera's display screen or an external display screen (e.g., a TV screen or a computer monitor) driven by the digital camera. The number of images scrolled across a display screen can be adjusted for ease and efficiency of viewing based on user preference. The camera provides controls for image scrolling including speed adjustment, forward scrolling, reverse scrolling, scroll pausing, and scroll resuming. The camera permits images to be locked in place on the display screen during the scrolling slideshow, which provides for easy comparison with other images that continue to scroll across the display screen. When an image is locked, scrolling images appear to scroll to a position behind the locked image.

### BACKGROUND

Digital cameras provide various ways for users to review captured images. One common way is to enable a user to review captured images directly on an LCD (liquid crystal display) screen of the digital camera. For many digital cameras, this type of review includes an option for displaying images one-at-a-time on the LCD screen and an option for displaying images in a thumbnail index where multiple images appear on the LCD screen at the same time. Another way to review captured images can include attaching the digital camera to a computer device, such as a PC, a printer, or an all-in-one device that includes a printer and an image viewer. Still another way to review captured images may include attaching the camera to a television set. Many digital cameras include a video output that permits viewing images captured by the camera on a TV screen.

For many digital cameras, these methods of reviewing images are adequate in terms of the speed and accuracy with which images from a digital camera can be reviewed. However, the number of images that digital cameras can store is increasing dramatically. For example, many conventional digital cameras use removable memory devices that can range is size from about 32 megabytes to about 512 megabytes. Removable memory devices come in such forms as compact flash cards, smart media cards, memory sticks, and the like. The larger removable memory devices (e.g., 512 megabytes) can enable a digital camera to store as many as 2,500 pictures, depending on data resolution and compression settings on the camera.

Prior methods for reviewing images stored on digital cameras are quickly becoming inadequate in light of the dramatic increase in the number of images digital cameras can store. Reviewing such a large number of images one-by-one on a camera's LCD screen, a TV screen, or a computer screen can be a cumbersome task. Moreover, the previous methods for reviewing images make it virtually impossible to make side-by-side comparisons of images. The problem of making side-by-side comparisons of images is exacerbated by the increasing number of images that can be stored in the memory of a digital camera.

### SUMMARY

A digital camera enables scrolling images across a display screen. The speed of the scrolling is adjustable, and images can be locked in place while other images continue to scroll across the display screen.

### BRIEF DESCRIPTION OF THE DRAWINGS

The same reference numbers are used throughout the drawings to reference like components and features.

FIG. 1 illustrates an exemplary embodiment of a digital camera suitable for providing a scrolling slideshow of images across a display screen.

FIG. 2 is a block diagram illustrating an example architecture of a digital camera such as that shown in FIG. 1.

FIG. 3 is a block diagram illustrating a more detailed representation of an example architecture of a digital camera such as that shown in FIG. 2.

FIG. 4 illustrates an exemplary embodiment of a main controller on a digital camera.

FIG. 5 illustrates an exemplary embodiment of a sequence of menus that might be displayed on a display screen during the setup of a scrolling slideshow.

FIG. 6 illustrates an example of digital camera images moving across a display screen in a scrolling slideshow.

FIG. 7 illustrates the images shown in FIG. 6 as they proceed to scroll across the display screen in a scrolling slideshow.

FIG. 8 illustrates an example of digital camera images moving across a display screen in a scrolling slideshow wherein one of the images has been locked in place on the screen.

FIG. 9 illustrates the images shown in FIG. 8 as they proceed to scroll across the display screen and behind the locked image.

FIG. 10 illustrates an example of a scrolling slideshow as it might appear on a widescreen format display, such as an HDTV.

FIG. 11 illustrates another example of a scrolling slideshow as it might appear on a widescreen format display, such as an HDTV.

FIG. 12 is a flow diagram illustrating an example method of providing a scrolling slideshow of digital camera images across a display screen.

### DETAILED DESCRIPTION

Overview

The following discussion is directed to a digital camera and related methods that enable a scrolling slideshow of captured images across a display screen. The display screen can be the digital camera's display screen or an external display screen (e.g., a TV screen or a computer monitor) being driven by the digital camera. The number of images being scrolled across a display screen at one time can be adjusted for ease and efficiency of viewing based on user preference. The camera provides controls for image scrolling including speed adjustment, forward scrolling, reverse scrolling, scroll pausing, and scroll resuming. The camera permits images to be locked in place on the display screen during the scrolling slideshow, which provides for easy comparison with other images that continue to scroll across the display screen. When an image is locked, scrolling images appear to scroll to a position behind the locked image.

Advantages of the disclosed digital camera and methods include the ability to quickly review large numbers of images captured by the camera and the ability to perform a side-by-side comparison of images through the slideshow image locking feature.

Exemplary System Environment

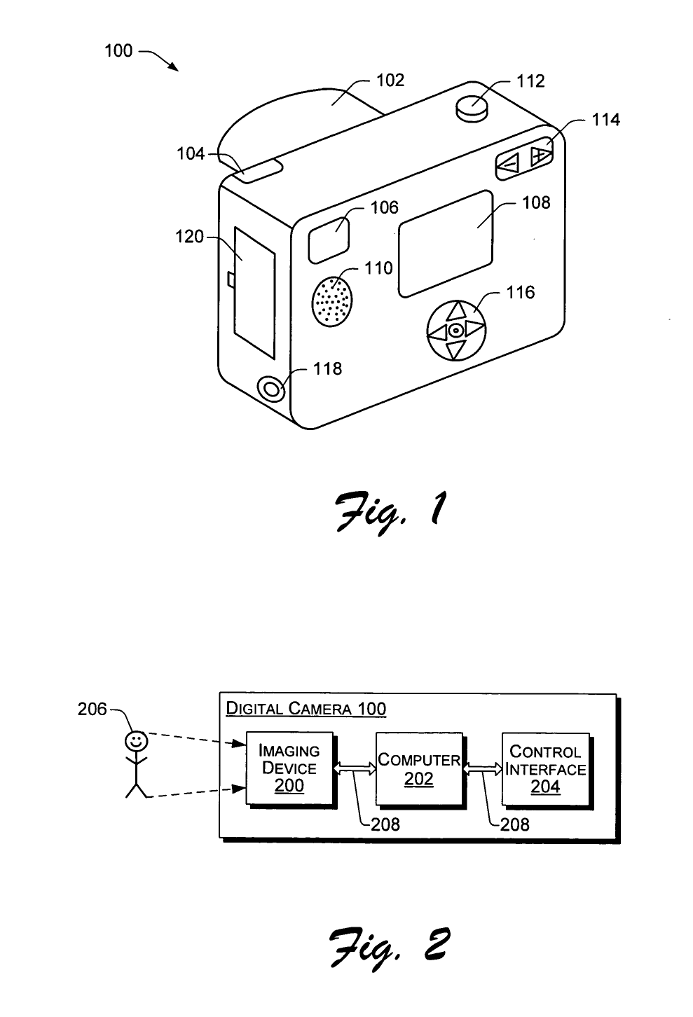

FIG. 1 illustrates an exemplary digital camera system 100 suitable for providing a scrolling slideshow of images across a display screen. The digital camera 100 electronically captures object images and stores them on an electronic/digital recording medium. The captured images can be reviewed in a number of ways, including on an LCD (liquid crystal display) screen of the digital camera.

The exemplary digital camera 100 illustrated in FIG. 1 includes an external architecture that has various mechanisms configured to control and perform camera functions, such as image capture and image display functions. The mechanisms include a lens system 102 and electronic flash 104 that are configured to perform a photographic image capture process. Lens system 102 is typically an electrically driven autofocus/telephoto lens system, the focal length of which may be adjusted from a wide angle setting to a close-up telephoto setting by adjusting a zoom control switch 114.

Additional mechanisms of digital camera 100 may include, for example, a viewfinder 106, an LCD screen 108, a microphone 110, an image capture button 112, the zoom control switch 114, a main controller 116, an audio/video (A/V) output terminal 118, and a wireless interface (not shown) such as 802.11 or Bluetooth. LCD screen 108 and A/V output terminal 118 or a wireless interface (e.g., 802.11 or Bluetooth) enable viewing of captured images in several ways, such as by displaying the images on the LCD screen 108 or on an external television screen, or by printing the images onto paper. LCD screen 108 also displays menus that are navigable and selectable via main controller 116 to control various settings and functions of digital camera 100.

Also illustrated on digital camera 100 is a media compartment 120 used to house removable electronic/digital photographic storage media. The removable storage media may include, for example, compact flash cards, smart media cards, memory sticks, and so on. Such storage media is inserted into camera 100 through compartment 120 to provide image storage capacity for digital camera 100. Camera 100 may also include other mechanisms not illustrated but commonly found on conventional film, digital, or hybrid cameras, such as an autofocus sensor, a light metering sensor, a lens cover system and the like.

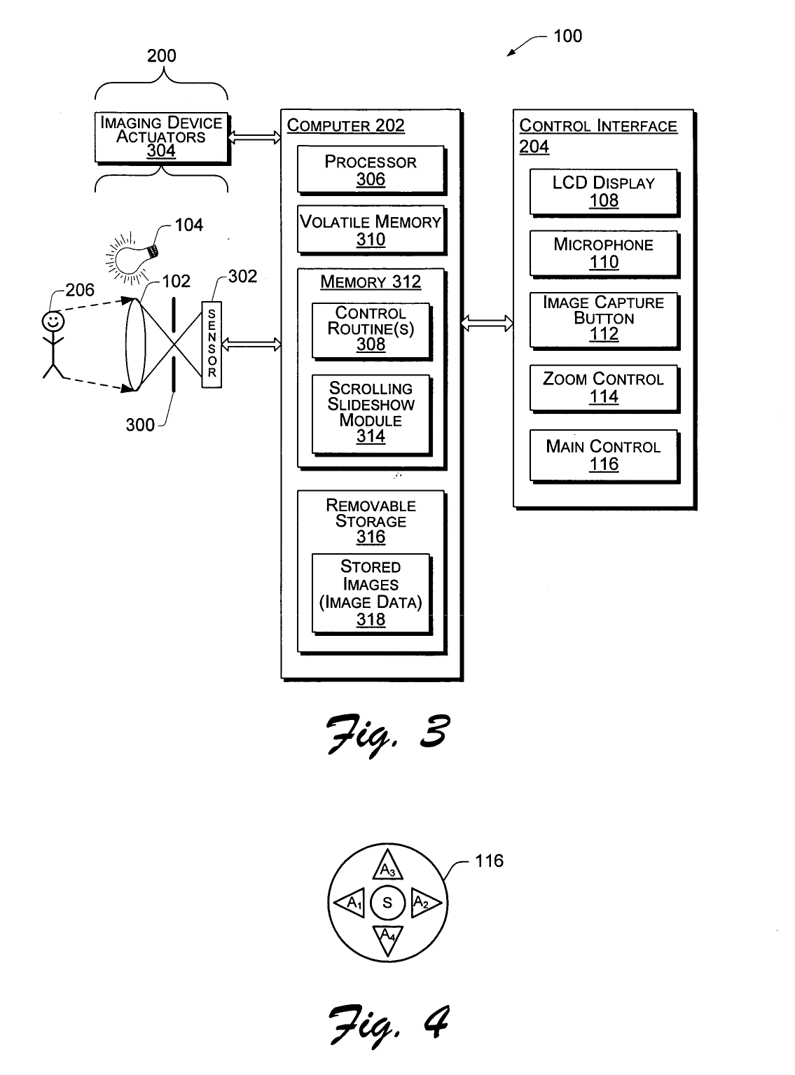

FIG. 2 is a high level block diagram illustrating an example architecture of digital camera 100. Digital camera 100 includes an imaging device 200, a computer 202 and a control interface 204. Imaging device 200 is optically coupled to an object 206 and electrically coupled via system bus 208 to computer 202. Control interface 204 is also coupled to computer 202 via system bus 208. In general, control of imaging device 200 is managed by computer 202 based on control signals initiated at control interface 204.

Referring generally to FIGS. 1 and 2, the architecture and mechanisms of digital camera 100 enable the camera 100 to capture object images and output those images for display in a variety of ways, including in a scrolling slideshow.

Exemplary Embodiments

FIG. 3 illustrates in greater detail, an exemplary embodiment of the digital camera 100 of FIGS. 1 and 2. In the embodiment of FIG. 3, camera 100 is based on a conventional digital camera. Accordingly, an imaging device 200 includes lens system 102, electronic flash 104, aperture 300, and electronic light sensor 302. Electronic light sensor 302 is typically implemented as a charge coupled device (CCD) or CMOS (complementary metal-oxide semiconductor) sensor. Electronic light sensors 302 in digital cameras provide exposure control that has the same effect as a mechanical shutter in a film camera. However, instead of interposing a mechanical light blocker, an electronic light sensor 302 limits exposure by constraining the sampling period. It is noted that, although a mechanical shutter is not illustrated on the digital camera 100 of FIG. 3, digital cameras often include a mechanical shutter. Mechanical shutters on a digital camera allow for improved image quality and may be necessary depending on the particular design of the electronic light sensor. Thus, a mechanical shutter may also be included on digital camera 100, although one is not illustrated in FIG. 3.

In addition to providing exposure control, electronic light sensor 302 serves as the initial capture medium for an image captured by digital camera 100. When an image is captured on electronic light sensor 302, each sensor element converts captured light into a voltage proportional to the brightness of the light. Voltages are passed through an analogue-to-digital converter (not shown) that ultimately translates the entire image into digital image data that is stored on a digital storage medium, such as a removable compact flash card.

Also included as part of imaging device 200 are imaging device actuators 304. Imaging device actuators 304 respond to input from computer 202 to control the various components of imaging device 200 such as the lens system 102, electronic flash 104, aperture 300, and electronic light sensor 302.

Computer 202 includes a conventional processor device 306 for controlling the operation of digital camera 100. Processor 306 is capable of concurrently executing multiple software control routines 308 and other executable instructions to control various processes of digital camera 100. Such processes are typically implemented through control of actuators 304. Actuators 304 may include various mechanisms configured to provide physical control over components such as lens system 102, electronic flash 104, aperture 300, and electronic light sensor 302. For example, an actuator 304 may include a motor configured to move the lens system 102.

Computer 202 additionally includes volatile memory 310 (i.e., RAM) and nonvolatile memory 312. Volatile memory 310 is a block of memory that is selectively allocable to various storage functions related to processes currently being controlled by processor 306. Nonvolatile memory 312 can include various computer storage media such as ROM, flash memory and a hard disk. Nonvolatile memory 312 stores processor-executable modules such as camera control routines 308 and scrolling slideshow module 314 configured to control camera functions. Nonvolatile memory 312 may, in some cases, also be used to store digital image data from images captured through imaging device 200.

Another form of nonvolatile memory included in digital camera 100 is removable storage 316. Removable storage 316 is a removable/replaceable memory device used to store digital image data 318 from images captured through imaging device 200. Removable storage device 316 may be implemented as various memory devices including, for example, a compact flash card, a smart media card, a memory stick, and the like. Removable storage devices 316 commonly range in size from about 32 megabytes to about 512 megabytes. Depending on the data resolution and compression settings on digital camera 100, a large removable storage device (e.g., 512 megabytes of memory) can enable digital camera 100 to store as many as 2,500 images. Removable storage devices 316 provide advantages including a significantly increased image storage capacity for digital camera 100 and an easy means for transferring a large number of images from the digital camera 100 to another device such as a PC having a removable storage input reader.

Control interface 204 includes input/output (I/O) mechanisms on the external architecture of digital camera 100 that enable a user to input and receive information related to controlling the operation of the camera 100. Thus, control interface 204 I/O mechanisms include LCD display screen 108, microphone 110, image capture button 112, zoom controller 114, main controller 116, and AN output terminal 118.

Settings and functions of digital camera 100 are manageable through main controller 116 in conjunction with associated menus that are driven by control routines 308 and displayed on LCD screen 108. As illustrated in FIG. 1, main controller 116 is a multi-control input button that includes left and right direction arrows, up and down direction arrows, and a center selection button. Menu items associated with various settings and functions of digital camera 100 are navigable and selectable through main controller 316 by pressing the direction arrows and selection button. For example, a user can access menu items that enable management of camera settings related to both capturing and displaying images. Thus, camera settings and functions related to lens 102 focus, flash 104, LCD screen 108, aperture 300, electronic light sensors 302, displaying images, and the like, are manageable through main controller 316. Operation of main controller 116 is discussed in greater detail below with respect to navigating and selecting camera settings from a menu and controlling various camera functions such as a display of images in a scrolling slideshow.

It is noted that main controller 316 is described throughout this disclosure by way of example only, as one of various types of controls that may be appropriate for managing settings and functions on digital camera 100. Thus, other types of controls are contemplated for managing settings and functions of digital camera 100. Such other controls may be implemented in a variety of ways, including, for example, as other multi-control buttons configured in a manner similar to or different from the main controller 316, or as numerous individual control buttons configured to support the same general managerial tasks performed by main controller 316. Accordingly, the description of main controller 316 and related components is not intended to indicate any limitation as to how settings, functions, or other items on digital camera 100 may be managed or controlled.

As indicated above, the operation of digital camera 100 is controlled by processor 306 through the execution of various processor-executable modules (e.g., camera control routines 308 and scrolling slideshow module 314) in conjunction with user input instructions. Input instructions are entered primarily through main controller 116, but also through other input controls such as image capture button 112 and zoom control switch 114. User activation of main controller 116 sends instructions to processor 306 in various ways. User activation of main controller 116 may include menu navigation and selection instructions for menus that are displayed on LCD screen 108. Menus displayed on LCD screen 108 enable a user to control digital camera settings regarding both the capturing of images and the playback or display of the captured images.

Digital camera 100 provides several modes/options for displaying captured images. Note that for any selected display option, images can be displayed on the LCD screen 108 of camera 100, or on an external display screen driven by the camera 100 through A/V output terminal 118 or a wireless interface (not shown), such as 802.11 or Bluetooth. One option is to display images “frame by frame”, or one image at a time. This option is generally known to those skilled in the art, and it allows a user to view one image at a time while stepping forward or backward through stored images. Another option for displaying captured images is through an index of images. The “image index” option is also generally known to those skilled in the art, and it permits a user to view a number of image thumbnails (e.g., nine image thumbnails) together on each frame of a display screen.

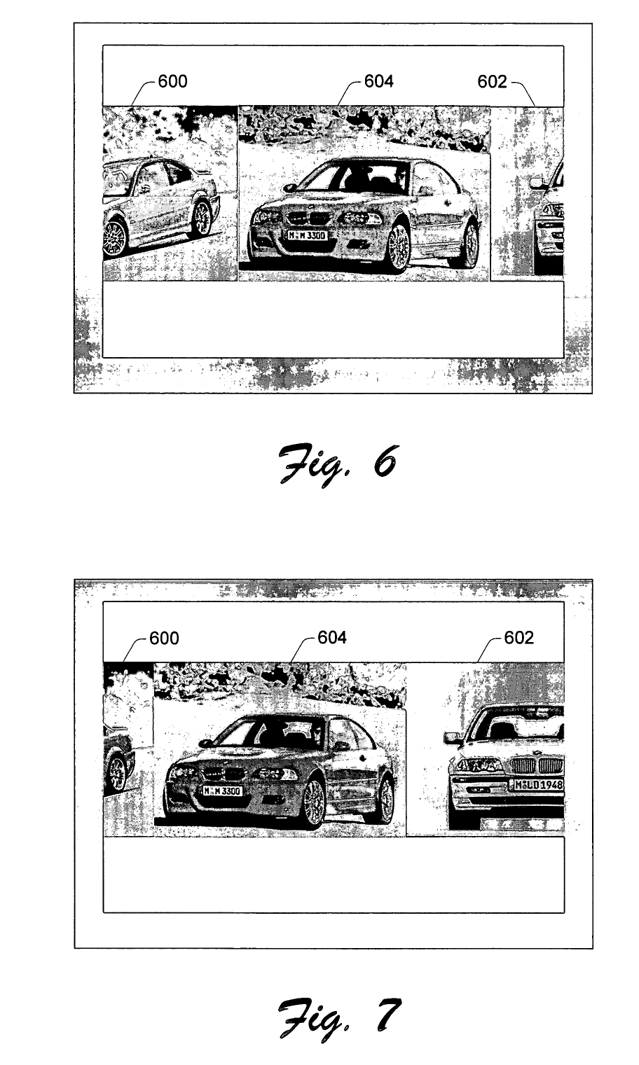

Still another option for displaying images from digital camera 100 is in a scrolling slideshow. Digital camera 100 includes scrolling slideshow module 314 that executes on processor 306 to manage a scrolling slideshow of images in conjunction with user instructions entered via main controller 116. In general, a scrolling slideshow enables a user to review and compare a number of images at the same time as the images scroll across a display screen. The scrolling slideshow is discussed in greater detail below with respect to FIGS. 6-11. First, however, the exemplary main controller 116 will be described in more detail to benefit further discussion of how the main controller 116 may be used to set up and control a scrolling slideshow.

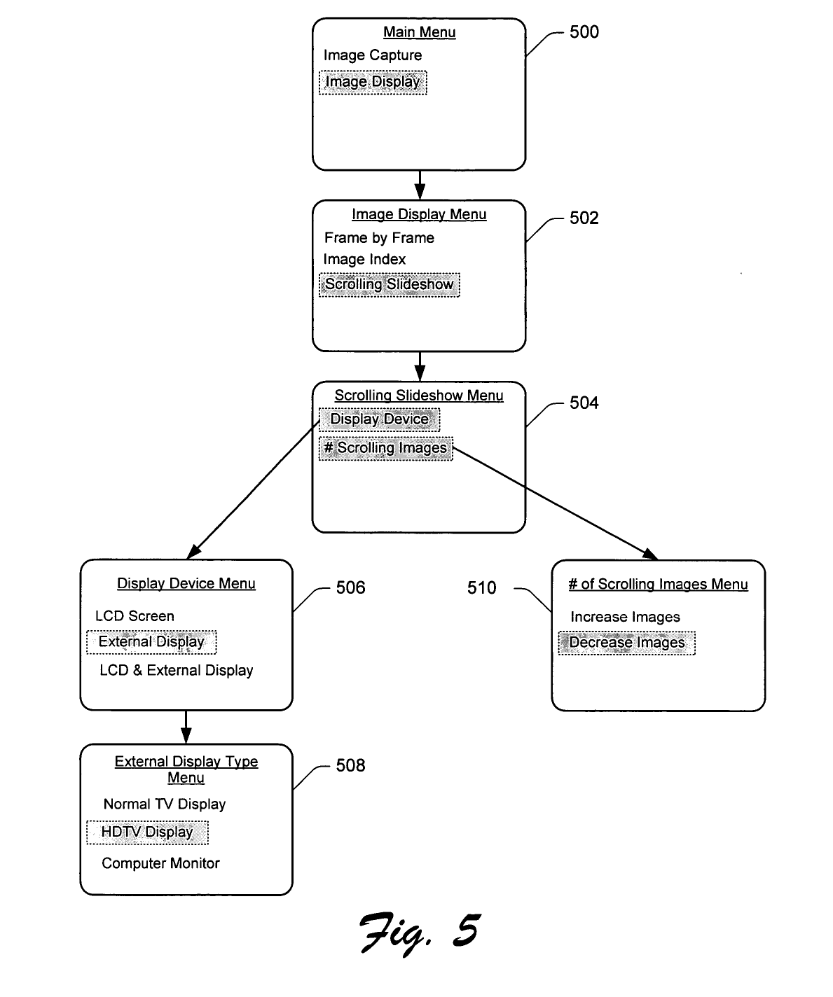

FIG. 4 illustrates the exemplary main controller 116 of digital camera 100. The exemplary main controller 116 includes several direction arrows labeled as A₁ through A₄, and a selection button labeled as S. Depending on the operation mode of the camera 100, these inputs provide different functions. For example, they provide for navigation and selection of menu items when camera settings are made from menus that are displayed on LCD screen 108 in a menu mode, while they provide for navigation and manipulation of images during an image display mode.

FIG. 5 illustrates an exemplary sequence of menus that might be displayed on LCD screen 108 during the setup of a scrolling slideshow. The sequence of menus in FIG. 5 is intended to illustrate one possible example of how a menu system might be implemented to configure a scrolling slideshow on digital camera 100. Thus, the menus illustrated in FIG. 5 are not intended to limit the scope of a scrolling slideshow or the manner by which a scrolling slideshow may be configured on a digital camera 100. In addition, various of the menu options discussed regarding a scrolling slideshow may be the default settings of camera 100 and may therefore not need to be actively selected by a user.

Referring to FIGS. 4 and 5, a user may access a menu system on digital camera 100, for example, by pressing the center selection (S) button of the main controller 116 (FIG. 4). Menus from digital camera 100 can be displayed on LCD screen 108 or on an external display screen (e.g., a TV screen or a computer monitor) driven by digital camera 100 through A/V output terminal 118. A “Main Menu” 500 (FIG. 5) may provide the user with options including, for example, accessing an “Image Capture” mode where camera settings related to capturing images can be adjusted, or accessing an “Image Display” mode where camera settings related to displaying captured images can be adjusted. Menu 500 indicates by the highlighted “Image Display” option, that a user has navigated to the “Image Display” mode (e.g., by pressing direction arrow A₄) and selected the “Image Display” mode (e.g., by pressing the center selection button S).

In response to the selection of the “Image Display” mode from menu 500, an “Image Display Menu” 502 is displayed which provides options for displaying images that have been captured and stored on digital camera 100. Image display menu 502 indicates that digital camera 100 provides several options for displaying captured images including the “Frame by Frame”, “Image Index”, and “Scrolling Slideshow” options mentioned above. It is noted that other image display options may also be available on digital camera 100, and that the options illustrated in any of the menus shown throughout FIG. 5 are not intended to limit the image display options or other functionality that may be available on digital camera 100.

The “Image Display Menu” 502 indicates that a user has navigated to, and selected, the “Scrolling Slideshow” option for displaying images. In response to this selection, a “Scrolling Slideshow Menu” 504 is displayed that provides options for what display device will be used for the scrolling slideshow and what number of images will be displayed at one time during the scrolling slideshow. FIG. 5 indicates that when the “Display Device” option is selected, a “Display Device Menu” 506 is displayed that provides options for the type of display device on which the scrolling slideshow is to be displayed. Menu 506 illustrates options for displaying images on the LCD screen 108 of the digital camera 100, an external display device, or both the LCD screen and an external device.

The “Display Device Menu” 506 indicates that a user has navigated to, and selected, the “External Display” option as the device on which the scrolling slideshow will be displayed. Had the “LCD Screen” option been selected, the scrolling slideshow would appear on the LCD screen 108. Likewise, had the “LCD & External Display” option been selected, the scrolling slideshow may appear on both the LCD screen 108 and an externally coupled display device, such as a TV or computer monitor. Displaying images on an external display device includes coupling such a device to digital camera 100. An external display device may be coupled to digital camera 100 in various ways, such as by a hardwire connection made through the A/V output terminal 118, or by a wireless connection made through various well-known wireless interfaces (not shown) such as 802.11 or Bluetooth. In response to the “External Display” selection, an “External. Display Type Menu” 508 is displayed that provides options for what type of external display device will be used to display the scrolling slideshow of images. The example options shown in menu 508 for an external display device include a “Normal TV Display”, an “HDTV (high definition TV) Display”, and a “Computer Monitor”. As noted above, these options are provided as examples and not limitations. Therefore, numerous other types of external display devices might also be provided as viable options.

Referring again to menu 504, the number of images scrolling across a display screen at one time can be altered by selecting the “# Scrolling Images” option. In response to a selection of this option, a “# of Scrolling Images Menu” 510 is displayed that provides options for increasing or decreasing the number of images scrolling across a display screen during a scrolling slideshow.

The number of images desired for scrolling across a display screen depends in part on the display device. For example, if a user chooses to view a scrolling slideshow on the LCD screen 108 of digital camera 100, the number of scrolling images may need to be relatively few (e.g., 2 or 3 images) because of the small size of the LCD screen 108. However, a user may want to increase the number of scrolling images if a larger, external display device such as a TV screen or an HDTV screen will be used for viewing the scrolling slideshow.

In addition, the desirable number of images to scroll across a display screen may increase or decrease based on the type of external display device being used to view the scrolling slideshow. This is due to the different aspect ratios that may be available on different external display devices. The “aspect ratio” of a display refers to the number of units of width by the number of units of height of the display. A normal TV's aspect ratio is 4:3, which produces an image that is more square, while an HDTV's aspect ratio is 16:9, which produces an image that is more panoramic in shape. The aspect ratio of a CinemaScope movie is 2.35:1. Thus, the choice of which external display device to use for viewing the scrolling slideshow informs the digital camera 100 what the aspect ratio is for the external display. This allows camera 100 to properly format the image data 318 before it is transferred to the external device through the A/V output terminal 118 or other interface such as an 802.11 or Bluetooth wireless interface (not shown).

FIGS. 6-11 illustrate various aspects of a scrolling slideshow. In general, the term scrolling should be understood to mean the movement of images (e.g., graphics, pictures, text, text incorporated within images, etc.) across a display screen as if the images were unrolled like a scroll. In FIGS. 6-11, as an exemplary default setting for digital camera 100, stored images 318 are scrolling from the right side of the screen to the left side of the screen. However, it is to be understood that images 318 may be scrolled across the screen in any direction, including right to left, left to right, top to bottom, or bottom to top. As another exemplary default setting, the scrolling slideshow presents the stored images 318 beginning with the most recently captured image and progressing toward the least recently captured image. However, it is noted that the scrolling slideshow may present stored images 318 beginning with other images, such as an image last reviewed in a previous scrolling slideshow, and so on.

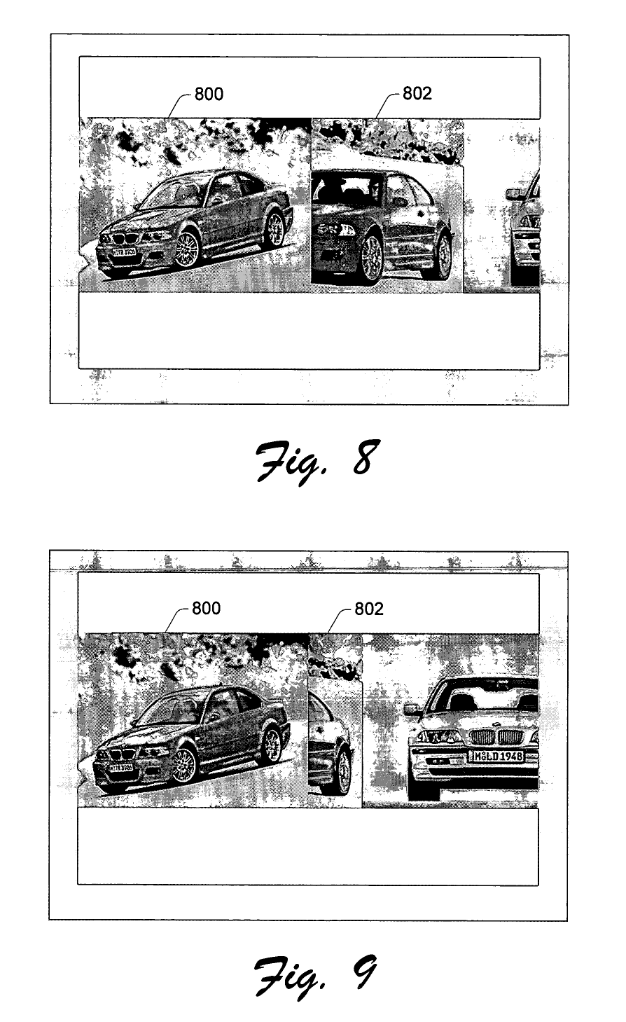

Aspects of a scrolling slideshow can be described with reference to FIGS. 6 and 7 and the main controller 116 of digital camera 100 as shown in FIG. 4. It is apparent from the illustrated display screen in FIGS. 6 and 7 that the number of images scrolling across the screen is set at two. Thus, as the first image 600 begins to scroll off the screen to the left, a third image 602 begins to scroll onto the screen from the right. The first and third images are therefore only partially displayed on the screen, while the second image 604 is fully displayed toward the center of the display screen. FIG. 7 illustrates a continuation of the scrolling images of FIG. 6, where the first image 600 is almost completely scrolled off of the display screen on the left side.

Digital camera 100 enables the exercise of numerous controls over the scrolling of images in a scrolling slideshow through main controller 116 (FIG. 4). It is noted that, although specific examples are described herein regarding how a scrolling slideshow of images may be controlled, the actual manner by which images may be controlled in a scrolling slideshow is completely arbitrary. Thus, it is understood that there may be many different ways to control the scrolling of images in a scrolling slideshow, using similar or different control mechanisms to those that are described herein.

Using the main controller 116 of FIG. 4 as an example, the digital camera 100 enables a user to control various scrolling features such as the starting, pausing, resuming, direction, and speed of the scrolling. Once digital camera 100 is set to a “Scrolling Slideshow” display mode (e.g., through menu 504, FIG. 5) the center select button, “S”, of main controller 116 can be used to “start” the scrolling of images. Once images are scrolling across the display screen, the select button “S” can be depressed to “pause” the scrolling. If the scrolling is paused, the select button “S” can again be depressed to “resume” the scrolling. Thus, the center select button “S” of main controller 116 can serve as a multi-function control (e.g., a “start” control, a “pause” control, a “resume” control, etc.) depending on the current status of the scrolling slideshow.

The direction in which images scroll across the display screen can be altered by pressing one of the direction arrows, A₁ or A₂, of main controller 116. For example, if images are initially scrolling from right to left across the display screen (i.e., the default direction), pressing the right direction arrow, A₂, will reverse the direction of scrolling so that images scroll from left to right across the screen. The direction of scrolling can also be changed by first pausing the scrolling as discussed above, and then pressing the right direction arrow, A₂, to resume scrolling in the opposite direction.

Direction arrows A₁ or A₂ can also function as speed controls for the scrolling slideshow. For example, if a scrolling slideshow of images is progressing across the display screen from right to left, depressing arrow A₁ will increase the speed with which images scroll from right to left. If the scrolling speed is already at an increased level from right to left, depressing the arrow A₂ will decrease the right to left scrolling speed. Additional pressing of arrow A₂ will decrease the right to left scrolling speed until the scrolling speed is at an initial starting speed, after which depressing arrow A₂ again will reverse the direction of scrolling as described above. In a similar way, the speed of images scrolling from left to right across the display screen can be controlled by depressing direction arrow A₂.

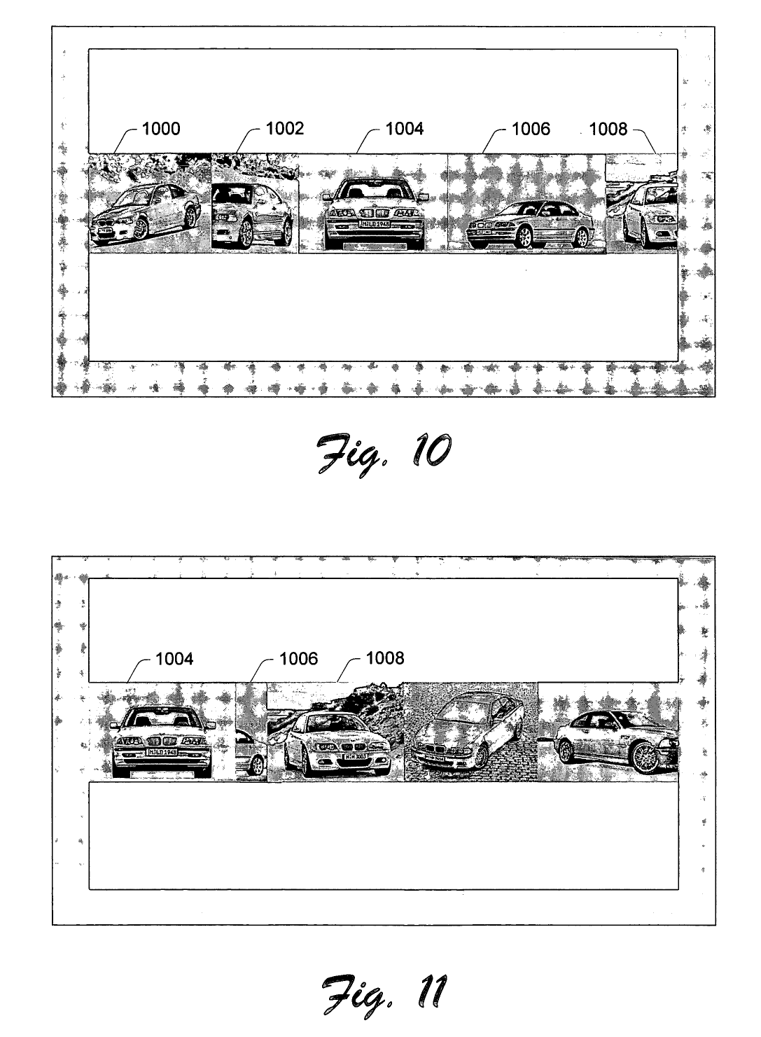

Additional features of a scrolling slideshow can be understood with reference to FIGS. 8 and 9. FIGS. 8 and 9 illustrate an “image locking” feature of the scrolling slideshow of digital camera 100. Image 800 has been locked on the display screen of FIGS. 8 and 9. When an image is locked on a display screen, it is preferably automatically justified to the side of the screen to which images are scrolling. Thus, when images are scrolling from right to left across a display screen, a locked image justifies to the left side of the screen as illustrated by image 800 of FIGS. 8 and 9. In addition, images that continue to scroll across the display screen, begin to scroll off the screen behind the locked image. Thus, image 802 begins to scroll behind locked image 800 in FIG. 8, and it continues to scroll behind locked image 800 until it finally disappears, as shown in FIG. 9.

The image locking feature also allows locked images to be unlocked and new images to be locked. In addition, more than one image can be locked on the screen depending on the size of the display screen. For example, if a scrolling slideshow is set up to display 3 images across a display screen, 2 images can be locked while other images continue scrolling across the remaining portion of the screen.

When an image is locked during a scrolling slideshow, other control features of the scrolling slideshow continue to work as described above. Thus, a user can pause and resume scrolling, and change direction and speed of scrolling for the images that continue to scroll on a display screen. The image locking feature provides a convenient way to compare a locked image to other stored images 318 that continue to scroll in a scrolling slideshow. The ability to compare images is enhanced when the image locking feature is used in conjunction with other scrolling control features such as scroll pause, scroll resume, scroll direction, and scroll speed.

Referring again to the main controller 116 of FIG. 4, an exemplary method for controlling the image locking feature can be described. During a scrolling slideshow, the direction arrow, A₃, can be pressed to lock an image on the display screen. There are various alternative implementations for locking an image. In one implementation, the image locked on the screen may be the image most closely aligned on the screen above the A₃ direction arrow at the time the A₃ arrow is pressed. In another implementation, the image locked on the screen may be the image closest to being justified in the direction in which images are scrolling. For example, if images are scrolling from right to left across a display screen, the image closest to being left justified on the screen would be the image locked when the A₃ direction arrow is pressed.

Locked images can be unlocked by pressing the A₄ direction arrow on main controller 116. Thus, if an image is locked on the display screen in a left justified position, pressing the A₄ arrow will unlock the locked image and permit it to scroll off the screen. If more than one image is locked on the display screen, various implementations are possible for unlocking the images. One implementation may include pressing the A₄ arrow one or more times in succession to unlock the image desired for unlocking. For example, if 3 images are locked on the screen, pressing the A₄ arrow 3 times in relatively fast succession will unlock the third locked image, while pressing the A₄ arrow one time will unlock the first locked image.

FIGS. 10 and 11 illustrate various features discussed above with reference to an exemplary scrolling slideshow as it might appear on a widescreen format display, such as an HDTV. In FIGS. 10 and 11, it is apparent that the number of images scrolling across the display screen (in a default direction of right to left) has been set to 4. In addition, in both FIGS. 10 and 11, an image has been locked on the display screen and is left justified while other images continue to scroll across the display screen and behind the locked image. In FIG. 10, image 1000 is locked into a left justified position, while images 1002, 1004, 1006 and 1008 continue to scroll across the screen and behind the locked image 1000. In FIG. 11, it is apparent that image 1000 from FIG. 10 has been unlocked and allowed to scroll off the screen, and that a new image 1004 has been locked on the display screen.

Exemplary Methods

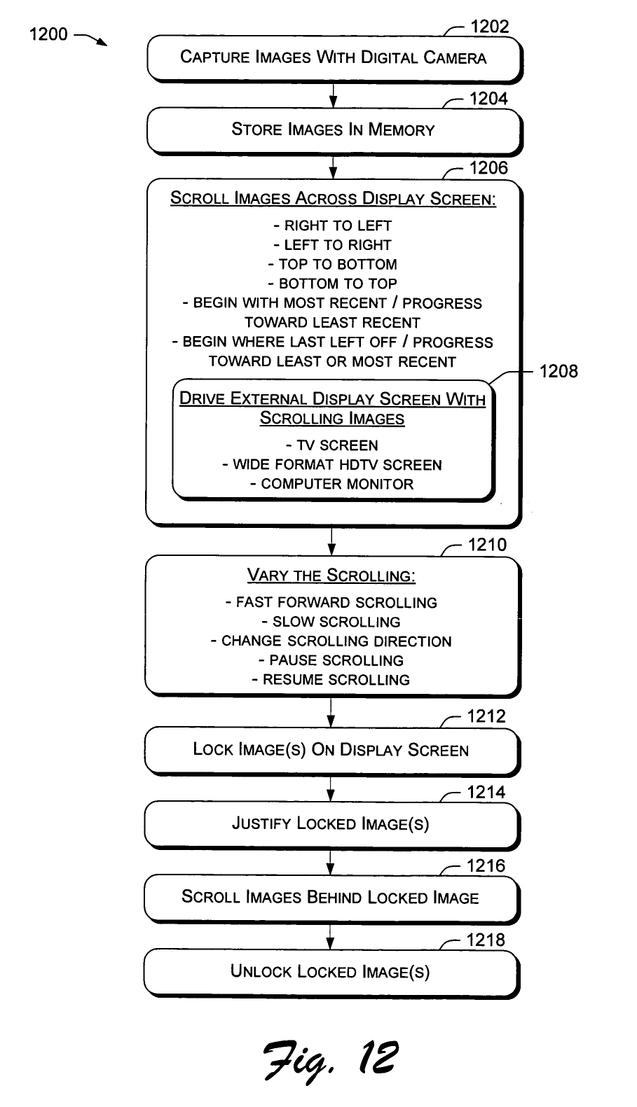

Example methods for providing a scrolling slideshow of images across a display screen will now be described with primary reference to the flow diagram of FIG. 12. The methods apply generally to the exemplary embodiments discussed above with respect to FIGS. 1-11. The elements of the described methods may be performed by any appropriate means including, for example, by hardware logic blocks on an ASIC or by the execution of processor-readable instructions defined on a processor-readable medium.

A “processor-readable medium,” as used herein, can be any means that can contain, store, communicate, propagate, or transport instructions for use or execution by a processor. A processor-readable medium can be, without limitation, an electronic, magnetic, optical, electromagnetic, infrared, or semiconductor system, apparatus, device, or propagation medium. More specific examples of a processor-readable medium include, among others, an electrical connection (electronic) having one or more wires, a portable computer diskette (magnetic), a random access memory (RAM), a read-only memory (ROM), an erasable programmable-read-only memory (EPROM or Flash memory), an optical fiber (optical), and a portable compact disc read-only memory (CDROM) (optical).

FIG. 12 shows an exemplary method 1200 for providing a scrolling slideshow of images from a digital camera 100 across a display screen. At block 1202, images are captured with a digital camera 100. An imaging device 200 of the camera 100 captures images as directed by the camera's computer 202 in response to user input entered through the camera's control interface 204. At block 1204, images 318 are stored in a memory of camera 100. The memory used for storing images 318 is usually a removable storage device 316 such as a compact flash card, a smart media card, a memory stick, and the like. However, the memory used for storing images 318 may also be the camera's internal non-volatile memory 312.

At block 1206 of method 1200, the captured images 318 are scrolled across a display screen in a scrolling slideshow. The display screen may be the LCD screen 108 on camera 100, an external display screen being driven the camera 100 as shown in block 1208, or both. External display devices can include display devices having a range of aspect ratios such as a normal format TV screen, a wide format HDTV, or a computer monitor. The images may scroll across the screen in various manners including, for example, from right to left, left to right, top to bottom, and bottom to top. The default for direction of scrolling is typically from right to left. The scrolling may progress in various ways, including for example, beginning with the most recently captured image and progressing toward the least recently captured image, or beginning with the last image left off in a previous scrolling slideshow and progressing either toward the least recently captured image or the most recently captured image.

At block 1210, the scrolling in a scrolling slideshow can be varied in numerous ways. For example, the speed of scrolling can be varied to provide fast-forward scrolling or slow scrolling. The direction of scrolling can be changed, for example, from a right to left direction to a left to right direction. The scrolling can also be paused and resumed from a paused condition.

At block 1212, one or more images scrolling across the screen can be locked in place on the screen. A locked image is typically justified to one side of the display screen as shown in block 1214. When images are locked on the display screen, scrolling continues with images on the remainder of the screen, and scrolling images scroll off the display screen as if they are scrolling behind the locked image(s) as shown at block 1216. At block 1218, a locked image or images can be unlocked. Unlocked images proceed to scroll off the screen, and new images can be locked on the screen.

While one or more methods have been disclosed by means of flow diagrams and text associated with the blocks of the flow diagrams, it is to be understood that the blocks do not necessarily have to be performed in the order in which they were presented, and that an alternative order(s) may result in similar advantages. Furthermore, the methods are not exclusive and can be performed alone or in combination with one another.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A processor-readable medium comprising processor-executable instructions configured for scrolling a number of images across a display screen of a digital camera.

2. A processor-readable medium as recited in claim 1, comprising further processor-executable instructions configured for varying the speed of the scrolling.

3. A processor-readable medium as recited in claim 2, wherein the varying the speed of the scrolling is selected from the group comprising:
fast-forwarding the scrolling;
slowing the scrolling;
reversing the scrolling;
pausing the scrolling; and
resuming the scrolling after the pausing.

4. A processor-readable medium as recited in claim 1, comprising further processor-executable instructions configured for:
locking an image in place on the display screen; and
scrolling images behind the locked image.

5. A processor-readable medium as recited in claim 4, wherein the locking an image comprises justifying the image at one edge of the display screen.

6. A processor-readable medium as recited in claim 4, comprising further processor-executable instructions configured for:
unlocking a locked image;
locking a new image in place on the display screen; and
scrolling images behind the new image.

7. A processor-readable medium as recited in claim 1, comprising further processor-executable instructions configured for altering the number of images being scrolled across the display screen.

8. A processor-readable medium as recited in claim 1, comprising further processor-executable instructions configured for driving an external display screen with the digital camera such that the multiple images are scrolled across the external display screen.

9. A processor-readable medium as recited in claim 8, wherein the external display screen is selected from the group comprising:
a television screen;
a high definition television screen having a widescreen format; and
a computer monitor.

10. A processor-readable medium as recited in claim 1, wherein the scrolling comprises moving the images across the display screen in a direction selected from the group comprising:
a left to right direction across the display screen;
a right to left direction across the display screen;
a top to bottom direction across the display screen; and
a bottom to top direction across the display screen.

11. A processor-readable medium as recited in claim 1, wherein the scrolling comprises presenting the images beginning with a most recently captured image and progressing toward a least recently captured image.

12. The digital camera comprising the processor-readable medium as recited in claim 1.

13. A method comprising:
capturing images with a digital camera;
storing the images in a memory of the digital camera; and
displaying the images as a scrolling slideshow on a display screen of the digital camera.

14. A method as recited in claim 13, further comprising:
fast-forwarding the scrolling slideshow;
slowing the scrolling slideshow;
reversing the scrolling slideshow;
pausing the scrolling slideshow; and
resuming the scrolling slideshow after the pausing.

15. A method as recited in claim 13, further comprising:
locking an image in place;
justifying the locked image at one side of the display screen; and
scrolling other images behind the locked image.

16. A method as recited in claim 13, wherein the displaying comprises displaying the images as a scrolling slideshow on an external display coupled to the digital camera.

17. A digital camera comprising:
a display screen;
captured images; and
a scrolling slideshow module configured to scroll the images across the display screen in a scrolling slideshow.

18. A digital camera as recited in claim 17, wherein the scrolling slideshow includes scrolling control features selected from the group comprising:
scroll pause;
scroll resume;
scroll speed;
scroll direction;
image locking; and
image unlocking.

19. A digital camera as recited in claim 18, further comprising a controller configured to manipulate the scrolling control features.

20. A digital camera as recited in claim 17, further comprising a memory configured to store image data, the memory selected from the group comprising:
an internal memory configured as part of the digital camera; and
a memory that is distinct from the digital camera, insertable within the digital camera, and removable from the digital camera.

21. A digital camera as recited in claim 17, further comprising an audio/video output terminal configured to couple the digital camera to an external display device, the scrolling slideshow module further configured to format the images for scrolling across the external display device.

22. A digital camera comprising:
means for capturing light on an electronic light sensor;
means for converting the light into digital data representing a plurality of images; and
means for scrolling the images across a display screen as a scrolling slideshow.

23. A digital camera as recited in claim 22, wherein the means for scrolling the images across a display screen comprise:
means for outputting the images to an external display screen; and
means for formatting the images for display on the external display screen.

24. A digital camera as recited in claim 22, wherein the means for scrolling the images across a display screen comprise:
means for pausing the scrolling;
means for resuming the scrolling;
means for changing direction of the scrolling;
means for changing speed of the scrolling;
means for locking an image in place on the display screen; and
means for unlocking a locked image.

25. A digital camera as recited in claim 22, wherein the means for scrolling the images across a display screen comprise:
means for increasing the number of images being scrolled across the display screen; and
means for decreasing the number of images begin scrolled across the display screen.
